(19) United States
(12) Patent Application Publication
(10) Pub. No.: US 2006/0168214 A1
(43) Pub. Date: Jul. 27, 2006

(54) System for managing logical partition preemption

(75) Inventors: William Joseph Armstrong, Rochester, MN (US); Richard Louis Arndt, Austin, TX (US); Michael Thomas Benhase, Tucson, AZ (US); Lawrence Carter Blount, Tucson, AZ (US); Yu-Cheng Hsu, Tucson, AZ (US); Naresh Nayar, Rochester, MN (US)

Correspondence Address: WOOD, HERRON & EVANS, L.L.P. (IBM), 2700 CAREW TOWER, 441 VINE STREET, CINCINNATI, OH, 45202, US

(73) Assignee: INTERNATIONAL BUSINESS MACHINES CORPORATION, ARMONK, NY (US)

(21) Appl. No.: 10/977,800

(22) Filed: Oct. 29, 2004

(51) Int. Cl. G06F 15/16; G06F 15/173

(52) U.S. Cl. 709/225; 709/200; 709/219

(57) ABSTRACT

An apparatus, program product and method guarantee a period of time in which a partition's use of a resource will not be preempted by a hypervisor. An inquiry communication from the partition prompts the hypervisor to determine if work is pending for the hypervisor. If not, the hypervisor sends a guarantee response ensuring the period of uninterrupted use of the resource by the partition.

### FIELD OF THE INVENTION

The present invention relates to computing systems, and more particularly, to dispatching virtual processors to central processing units within a logically partitioned environment.

### BACKGROUND OF THE INVENTION

The speed and efficiency of many computing applications depends upon the availability of processing resources. To this end, computing architectures such as the “virtual machine” design, developed by International Business Machines Corporation, share common processing resources among multiple processes. Such an architecture may conventionally rely upon a single computing machine having one or more physical processors, or central processing units (CPU's). The physical processors may execute software configured to simulate multiple virtual processors.

Virtual processors have particular application within a logically partitioned computing system. A partition may logically comprise a portion of a machine's physical processors, memory and other resources, as assigned by an administrator. As such, an administrator may share physical resources between partitions. Each partition typically hosts an operating system and may have multiple virtual processors. In this manner, each partition operates largely as if it is a separate computer.

An underlying program called a hypervisor, or partition manager, uses this scheme to assign and distribute physical resources to each partition. For instance, the hypervisor may intercept requests for resources from operating systems to globally share and allocate them. If the partitions are sharing processors, the hypervisor allocates physical processors between the virtual processors of the partitions sharing the processor.

In an effort to increase the processing speed of computer systems where partitions are sharing processors, system designers commonly implement hypervisor calls. The hypervisor calls function, in part, to coordinate use of physical resources between partitions. A relatively common hypervisor call is a request from a respective partition to the hypervisor asking to yield access to a physical processor. The hypervisor may then dispatch a virtual processor of another partition to the yielded physical processor. Once the virtual processor is dispatched to a physical processor, the virtual processor can access the processing cycles required to do its work.

Despite the efficiencies afforded by logically partitioned computer systems and their associated hypervisor calls, certain inherent complexities persist. For instance, yield calls cannot always be practically accomplished. In one example, a partition may not be programmed under certain operating conditions to yield a resource needed by another partition. In one common scenario, the virtual processor of the second partition may have more time critical or important work to do than does the preempted virtual processor. In such an instance, it is typically necessary for the hypervisor to preempt, or remove, a virtual processor of the first partition from a physical resource so that the virtual processor of the second partition can use the physical resource.

In preempting the virtual processor, however, the hypervisor may unwittingly preempt the first logical partition at an inopportune time. For example, the preempted partition may have been executing performance sensitive code, itself, and preemption at such a point may adversely impact system performance. Examples of sensitive code include global locks and task dispatches, as well as time sensitive operations, such as polling functions involving a host or device adaptor. Interrupting such sensitive operations creates performance concerns that can undermine the benefits realized by logically partitioned environments. There is consequently a continuing need for an improved manner of managing access to resources included within a logically partitioned data processing environment.

### SUMMARY OF THE INVENTION

Features of the present invention include an apparatus, method, and program product configured to manage access to physical resources included within a logically partitioned data processing system. The logically partitioned data processing system is configured to assign ownership of the physical resources to the plurality of partitions. To address the problems of the prior art, the system may grant a preset period of uninterrupted use of a physical resource to a partition. The system inhibits preemption of the resource during the preset period. This grant of uninterrupted use guarantees use of the resource for the partition, allowing the partition to work with increased efficiency. The partition may be accomplishing or preparing to accomplish work of a sensitive nature, for instance, or any type of work where a conventional preemption of the resource would be undesirable. Resources required by the partition to accomplish the work may include a physical processor and/or a memory.

The partition desiring uninterrupted use of the resource may create an inquiry communication configured to prompt a determination of whether work is pending at the hypervisor. If no work is pending at the hypervisor, the hypervisor may in response to the determination create a guarantee response. The guarantee response may function to guarantee that the work of the partition will not be interrupted by the hypervisor, i.e., the use of the physical resource will not be preempted for the duration of a preset period. In receiving the guarantee response, the partition may schedule work to be performed by the partition. If in response to the inquiry communication the hypervisor alternatively determines that there is pending hypervisor work, the hypervisor may instead create and send a work pending response. The partition may yield the physical resource to the hypervisor in response to receiving the work pending response.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a block diagram of a computer consistent with the invention.

FIG. 2 is a block diagram of the primary software components and resources of the computer of FIG. 1.

FIG. 3 is a flowchart having steps initiated by a partition of FIG. 2 for the purpose of seeking guaranteed uninterrupted access to a physical resource of FIG. 2.

FIG. 4 is a flowchart having steps accomplished by the shared services portion of the hypervisor of FIG. 2 in response to an inquiry call created in FIG. 3.

FIG. 5 is a flowchart having steps accomplished by the shared services portion of the hypervisor of FIG. 2 in response to a yield call created in FIG. 3.

FIG. 6 is a flowchart having steps accomplished by the shared services portion of the hypervisor of FIG. 2 in response to pending work.

### DETAILED DESCRIPTION

Features of the present invention include an apparatus, program product and method for distributing work within a logically partitioned computer system by guaranteeing access to a physical resource for a partition for a preset, guarantee period. To this end, an inquiry hypervisor call is supported to allow a partition to query for the existence of pending hypervisor work. The presence of pending hypervisor work typically means that a virtual processor of the hypervisor partition will need access to the cycles of a processor to accomplish the pending work. That is, the hypervisor will need to preempt use of the physical processor. If the inquiry hypervisor call returns a response that indicates that no pending work exists, then the hypervisor essentially guarantees that the physical processor or other resource on which the call is made will not be the target of hypervisor preemption for the duration of a preset period. This duration, or guarantee period, is typically an implementation dependent constant. In one embodiment consistent with the invention, however, the duration of the preset period may vary. For instance, a partition may request a specific period, or the hypervisor may return a specific period that varies in duration depending on various operating factors, e.g., the type of pending work, estimated time required to complete the work, anticipated workload, processor availability, etc. In one embodiment, the guarantee may apply to every resource associated with a given partition. Another embodiment may guarantee use of specific resources, e.g., a particular processor assigned to a partition.

More particularly, a virtual processor of a partition seeking a guarantee makes an inquiry communication, or call. If there is no hypervisor partition work pending, the hypervisor records in the virtual processor control block the time it has guaranteed the virtual processor will not be preempted. If hypervisor partition work subsequently becomes pending, and the hypervisor gets control of the processor (e.g., a hypervisor decrementor interrupt) prior to the preemption-free time it guaranteed to the virtual processor, the virtual processor is not preempted. Any preemption occurs the next time the hypervisor gets control after the guaranteed preset period has expired, or the partition yields the resource because the virtual processor has entered a waiting state.

Hardware and Software Environment

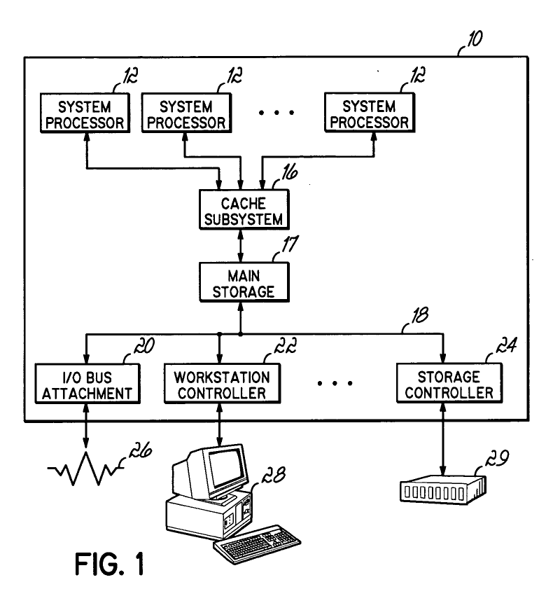

Turning more particularly to the drawings, wherein like numbers denote like parts throughout the several views, FIG. 1 illustrates a data processing apparatus 10 consistent with the invention. Apparatus 10 generically represents, for example, any of a number of multi-user computer systems such as a network server, a midrange computer, a mainframe computer, etc. However, it should be appreciated that the invention may be implemented in other data processing apparatus, e.g., in stand-alone or single-user computer systems such as workstations, desktop computers, portable computers, and the like, or in other computing devices such as embedded controllers and the like. One suitable implementation of apparatus 10 is in a midrange computer such as an iSeries computer available from International Business Machines Corporation.

Apparatus 10 generally includes one or more physical processors 12 coupled to a memory subsystem including main storage 17, e.g., an array of dynamic random access memory (DRAM). Where desired, the physical processors may be multithreaded. Also illustrated as interposed between multithreaded physical processors 12 and main storage 17 is a cache subsystem 16, typically including one or more levels of data, instruction and/or combination caches, with certain caches either serving individual processors or multiple processors as is well known in the art.

Furthermore, main storage 17 is coupled to a number of types of external (I/O) devices via a system bus 18 and a plurality of interface devices, e.g., an input/output bus attachment interface 20, a workstation controller 22 and a storage controller 24, which respectively provide external access to one or more external networks 26, one or more workstations 28, and/or one or more storage devices, such as a direct access storage device (DASD) 29.

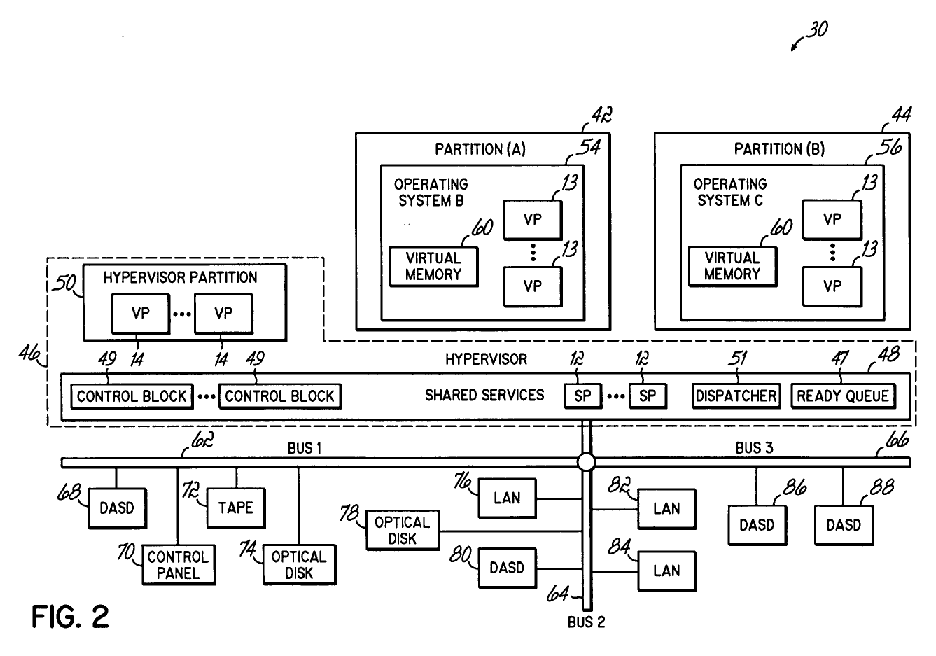

The system of FIG. 2 illustrates in greater detail the primary software components and resources utilized in implementing a logically partitioned apparatus similar to that of FIG. 1, including a plurality of logical partitions 42, 44 managed by a hypervisor 46, (which may also be referred to as a partition manager). Any number of logical partitions may be supported in the system as is well known in the art. Each logical partition 42, 44 utilizes an operating system (e.g., operating systems 54 and 56 for logical partitions 42 and 44, respectively), that controls the primary operations of the logical partition in the same manner as the operating system of a non-partitioned computer. Each logical partition 42, 44 executes in a separate memory space, represented by virtual memory 60. Moreover, each logical partition 42, 44 is statically and/or dynamically allocated a portion of the available resources in apparatus 30. For example, each logical partition may share one or more physical processors 12, as well as a portion of the available memory space for use in virtual memory 60. In this manner, a given physical processor 12 may be utilized by virtual processors 13 of more than one logical partition.

The hypervisor 46 shown in FIG. 2 includes program code responsible for partition integrity and partition management. To this end, the hypervisor 46 typically includes two layers of software. One such layer may include the shared services block 48, which may be invoked by a logical partition through a hypervisor call. The shared services block 48 layer of code is typically invoked for functions that include partition and virtual processor management, including physical processor dispatching and may have no concept of tasks.

A second layer of code of the hypervisor 46 includes a hypervisor partition 50. The hypervisor partition 50 is generally used to perform relatively high level operations. Such operations may include an initial program load (IPL) on a partition or concurrent input/output maintenance, for example. This layer of code runs with relocation on and may execute tasks similar to an operating system. In this manner, the hypervisor partition 50 functions as a logical partition on the system 30, except that is typically hidden from the user. That is, the hypervisor partition 50 typically does not have a user interface like a conventional operating system. One skilled in the art will appreciate that the hypervisor partition of another embodiment may reside within a conventional partition, as opposed to inside a dedicated partition as shown in FIG. 2.

The hypervisor partition 50 functions in many ways like the conventional partitions 42, 44 (and operating systems), but has no user interface for the customer. Because the hypervisor partition 50 by design lacks a user interface, it is “hidden” from the user. This hidden feature protects the hypervisor partition from failures that might otherwise come about through user interaction. For instance, where commands input to a conventional operating system cause the operating system to crash, the computer system 30 may still have the use of the hypervisor partition, possibly to complete the work of the failing operating system. The system 30 may thus use the hypervisor partition 50 as an additional resource of virtual processors, e.g., virtual processors 14.

The hypervisor partition 50 may make special hypervisor calls configured to preempt a resource of a partition to accomplish the work of the hypervisor partition 50. As such, the hypervisor partition 50 may make a hypervisor call to the shared services block 48 of the hypervisor 46. The shared services block 48 is responsible for managing the dispatching of virtual processors to physical processors on a dispatch list, or ready queue 47. The ready queue 47 comprises memory that includes a list of virtual processors having work that is waiting to be dispatched on a physical processor 12. Virtual processors added to the list comprising the ready queue 47 are said to be “read to run.”

In this manner, a hypervisor call generated by the hypervisor partition 50 may initiate preempting a virtual processor that would otherwise be dispatched on the physical processor. For instance, such a call may function to preempt another virtual processor that was already waiting on the ready queue. Another such call may result in a virtual processor losing access to the physical processor to allow use by the bound virtual processor of the hypervisor partition 50.

Since the hypervisor partition 50 is hidden from the system administrator, there is no physical processor capability assigned to it. The hypervisor dispatcher 51, which is in the shared services block 48 of the hypervisor 46, must consequently steal physical processor cycles to run the virtual processors 14 of the hypervisor partition 50. Absent processes of the present invention, a hypervisor dispatcher 51 seeking to steal processing cycles may preempt a logical partition 42 from a physical processor 12 at an inopportune time. For example, the logical partition 42 may be executing a polling function involving an adaptor. Preemption during the polling function could noticeably and negatively affect system performance.

The work performed by the hypervisor partition 50 may generally be categorized into three broad categories. In the first category, some work performed by the hypervisor partition 50 may be generated by a specific partition. Examples of such work may include IPL's of a partition, powering-off a partition, and executing a main store dump of a partition. A second work source may include platform work. Examples of such work are platform error recovery, as well as interaction with the service processor or the hardware management console. A third source of work accomplished by the hypervisor partition 50 may include work that has to be performed on a specific physical processor 12. Examples of such work include running diagnostic tests on a physical processor 12 in the system.

In one embodiment consistent with the principles of the present invention, work that is generated by a partition 42 may be performed by using the physical processors 12 assigned to that partition 42. For example, processor cycle stealing accomplished by the shared services block 48 of the hypervisor 46 may occur from the set of dedicated physical processors that are assigned to the partition that generated the work. A dedicated processor partition is a partition that has exclusive use of a physical processor assigned to it. For a shared processor partition, the work may be performed by a physical processor in a shared pool of that partition that generated the work. A shared processor partition is a partition that shares physical processors with other shared processor partitions. Finally, work that is specific to a physical processor may be performed on that physical processor in order for the effects of the work to be realized on the physical processor.

The hypervisor 46 shown in FIG. 2 also includes physical processors 12, in addition to processor control blocks 49. The processor control blocks 49 comprise memory that includes a list of virtual processors 13, 14 waiting for access on a particular physical processor 12. The process in which the virtual processor of the hypervisor or other partition is dispatched to a physical resource may include marking a control block 49 of the bound virtual processor so that it is associated with the physical resource.

Additional resources, e.g., mass storage, backup storage, user input, network connections, and the like, are typically allocated to one or more logical partitions in a manner well known in the art. Resources can be allocated in a number of manners, e.g., on a bus-by-bus basis, or on a resource-by-resource basis, with multiple logical partitions sharing resources on the same bus. Some resources may even be allocated to multiple logical partitions at a time. FIG. 2 illustrates, for example, three logical buses 62, 64 and 66, with a plurality of resources on bus 62, including a direct access storage device (DASD) 68, a control panel 70, a tape drive 72 and an optical disk drive 74, allocated to a partition.

Bus 64, on the other hand, may have resources allocated on a resource-by-resource basis, e.g., with local area network (LAN) adaptor 76, optical disk drive 78 and DASD 80 allocated to logical partition 42, and LAN adaptors 82 and 84 allocated to logical partition 44. Bus 66 may represent, for example, a bus allocated specifically to logical partition 44, such that all resources on the bus, e.g., DASD's 86 and 88, are allocated to the same logical partition.

It will be appreciated that the illustration of specific resources in FIG. 2 is merely exemplary in nature, and that any combination and arrangement of resources may be allocated to any logical partition in the alternative. For instance, while only one hypervisor partition 50 is shown in FIG. 2, one skilled in the art will appreciate that more such partitions may be included if desired. Moreover, it will be appreciated that in some implementations resources can be reallocated on a dynamic basis to service the needs of other logical partitions. Furthermore, it will be appreciated that resources may also be represented in terms of the input/output processors (IOP's) used to interface the computer with the specific hardware devices.

The various software components and resources illustrated in FIG. 2 and implementing the embodiments of the invention may be accomplished in a number of manners, including using various computer software applications, routines, components, programs, objects, modules, data structures, etc., referred to hereinafter as “computer programs,” “programs” or “program code.” Program code typically comprises one or more instructions that are resident at various times in various memory and storage devices in the computer, and that, when read and executed by one or more processors in the computer, cause that computer to perform the steps necessary to execute steps or elements embodying the various aspects of the invention.

Moreover, while the invention has and hereinafter will be described in the context of fully functioning computers, those skilled in the art will appreciate that the various embodiments of the invention are capable of being distributed as a program product in a variety of forms, and that the invention applies equally regardless of the particular type of computer readable signal bearing medium used to actually carry out the distribution. Examples of computer readable signal bearing media include but are not limited to recordable type media such as volatile and non-volatile memory devices, floppy and other removable disks, hard disk drives, magnetic tape, optical disks (e.g., CD-ROM's, DVD's, etc.), among others, and transmission type media such as digital and analog communication links.

In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Those skilled in the art will recognize that the exemplary environments illustrated in FIGS. 1 and 2 are not intended to limit the present invention. Indeed, those skilled in the art will recognize that other alternative hardware and/or software environments may be used without departing from the scope of the invention.

Processes for Guaranteeing Resource Availability

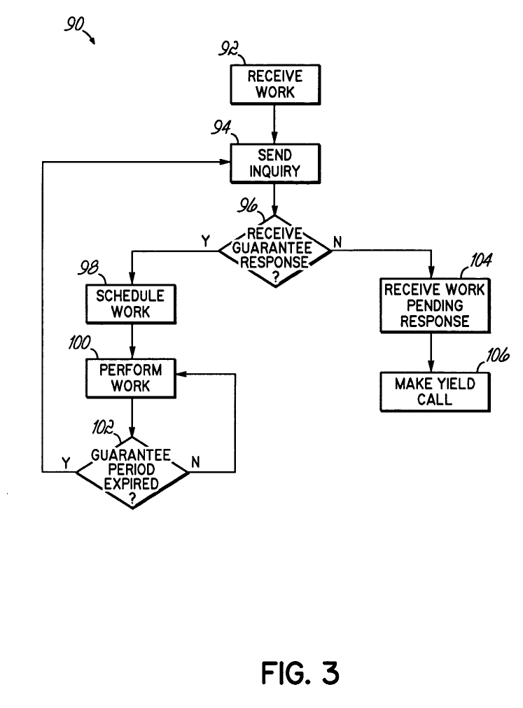

FIG. 3 shows a flowchart 90 having a set of exemplary steps executable by the hardware and software systems of FIGS. 1 and 2. More particularly, the steps of the flowchart 90 may be accomplished by a partition 42 seeking a guarantee of uninterrupted work. That is, the partition may desire guaranteed access to a physical resource for a preset period of no preemption by the hypervisor. Turning specifically to block 92 of FIG. 3, the partition 42 receives work in the course of normal operation. That is, a control queue of the partition 42 registers work to be performed by the partition 42. The partition control queue may comprise a list of work to be accomplished and is used to manage work for the partition 42. Some such work may be sensitive in nature and/or affect performance of the system 30. Examples of such sensitive work may include a cache service, initiation of a staging or destaging operation, and a polling function involving a host or device adaptor.

In response to receiving the work at block 92, the partition 42 may generate an inquiry communication at block 94. By sending the inquiry communication at block 94 the partition 42 is seeking a guarantee that the partition 42 may accomplish its work without having processing cycles of its physical processor 12 reallocated to the hypervisor's, or in another embodiment, some other partition. The inquiry communication where desired may be generated only in response to sensitive or an otherwise designated type of work, such as the polling function of the above example. Another embodiment may alternatively generate the inquiry communication in response to all work. One skilled in the art will thus appreciate that the programmable conditions upon which the guarantee processes of the present invention are invoked may vary per application specifications.

Of note, the partition 42 seeking the guarantee may have already been using the resource required to accomplish the performance sensitive work at the time work is received at block 92. That is, a virtual processor 13 may have previously been dispatched by the shared services block 48 of the hypervisor 46 to a physical processor 12.

In any case, the inquiry communication created at block 94 may be addressed for electronic delivery to the shared services portion 48 of the hypervisor 46. The hypervisor 46 may have access to delivery information associated with the inquiry communication. This delivery information is used to identify the partition 42 to the hypervisor 46.

In response to the inquiry communication of block 94, the partition 42 may receive a guarantee response from the hypervisor 46 at block 96 of FIG. 3. The guarantee response assures the partition 42 that it may proceed to accomplish partition work without having processing cycles of its Physical processor 12 preempted and re-distributed to the hypervisor partition 50.

As discussed herein, the hypervisor partition 50 functions in some ways like a conventional operating system. However, the hypervisor partition 50 includes no interface for a user. This feature protects the hypervisor partition 50 from causes of failure to which conventional operating systems may in some instances be otherwise vulnerable. As such, the hypervisor partition 50 may function as a robust source of virtual processing power for the system 30.

Where such a guarantee response is received at block 96, the partition 42 may schedule work at block 98. Namely, the partition 42 may schedule the sensitive or other pending work that prompted the inquiry at block 94. The partition 42 subsequently uses an assigned physical processor 12 resource to perform the work at block 100. The partition 42 performs such work at block 100 without interruption from the hypervisor 46 until a preset guarantee period expires at block 102. In one embodiment, the guarantee period may be communicated with the guarantee response received at block 96. The guarantee period of another embodiment may be a preset default period e.g., retrieved from memory by the hypervisor 46, e.g., 100 milliseconds. Where the guarantee period has expired at block 102, the partition 42 may initiate another inquiry communication at block 94 for the same or different work.

Where in response to the inquiry communication at block 94, the partition 42 alternatively at block 104 receives a work pending response, the partition 42 may prepare to yield its associated physical processor 12. The partition 42 may receive the work pending response from the shared services portion 48 of the hypervisor 46. As discussed herein, a work pending response may be received when the hypervisor 46 expects to require a physical processor 12 or other resource within a time period that could result in interruption of the work of the partition 42.

In response to receiving the work pending response at block 104, the partition 42 may make a yield call at block 106. Different yield calls are known in the art, and generally function, in part, to surrender the physical processor 12 to the hypervisor 46.

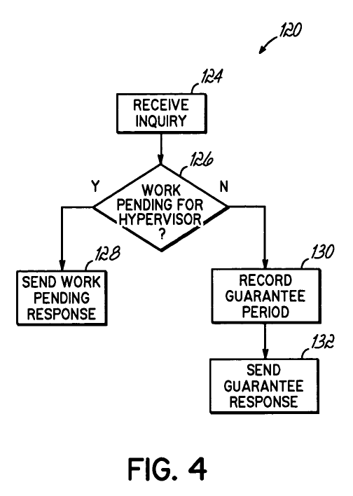

FIG. 4 shows a flowchart 120 having a set of exemplary steps executable by the hardware and software systems of FIGS. 1 and 2. More specifically, the steps of FIG. 4 may be accomplished by the shared services portion 48 of the hypervisor 46 of FIG. 2 in response to an inquiry call created by the processes of FIG. 3. Turning more particularly to block 124 of FIG. 4, the hypervisor may receive at block 124 an inquiry communication from a partition 42. In response to receiving the inquiry communication, the hypervisor 46 may determine at block 126 whether any work is pending for the hypervisor 46. For instance, the hypervisor 46 may determine if work is pending for the hypervisor partition 50.

Where the hypervisor 46 determines that work is pending for the hypervisor partition 50 at block 126, then the shared services portion 48 of the hypervisor 46 may send a work pending response to the partition 42 at block 128. As discussed above, a work pending response may be generated when the hypervisor 46 expects to require a physical processor 12 or other resource within a time period that could result in interruption of the proposed work of the partition 42.

Where the hypervisor 46 alternatively determines at block 126 that it has no pending work, then the shared services portion 48 may record a guarantee period at block 130. This process may include recording the guarantee period in a control block 49 of the virtual processor 13 of the partition 42. The control block 49 comprises memory useful in identifying a bound status, for instance.

The hypervisor 46 may then send a guarantee response to the partition 42 at block 132. As discussed herein, the guarantee response functions to assure the partition 42 that it may proceed to accomplish partition work without having processing cycles of its physical processor 12 reallocated to the hypervisor's or some other partition. To this end, the guarantee response may include or otherwise be associated with a duration of time, or guarantee period, during which the partition 42 may accomplish its work without interruption from the hypervisor 46. One skilled in the art will appreciate that the guarantee period may be set according to application specifications, and moreover, different guarantee periods may be set for different kinds of work.

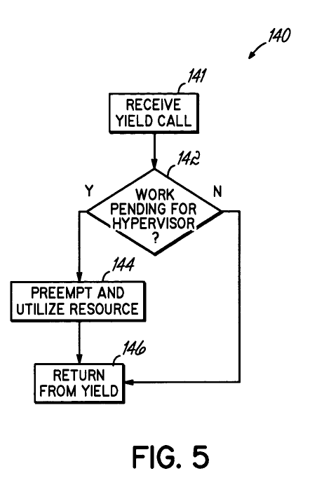

FIG. 5 is a flowchart 140 having steps accomplished by the shared services portion 48 of the hypervisor 46 of FIG. 2 in response to a yield call created by the processes of FIG. 3. Turning more particularly to block 142 of FIG. 5, the shared services portion 48 of the hypervisor 46 may receive the yield call from the partition 42. This yield call effectively surrenders the physical processor 12 or other resource to the hypervisor 46. If work is pending at the hypervisor 46 at block 142, then the hypervisor 46 may consequently preempt the virtual processor 13 and utilize the resource at block 144. For instance, the hypervisor 46 may perform a required a main storage dump using the physical processor 12. Control of the physical processor 12 is returned to the partition 42 at block 146, when the hypervisor 46 generates a return to yield call.

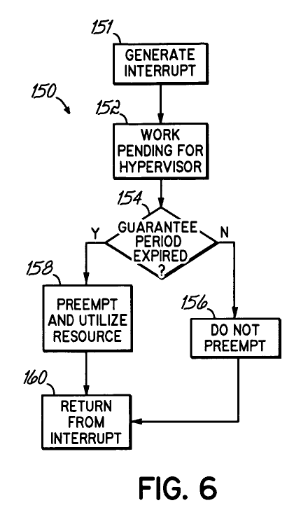

FIG. 6 is a flowchart 150 having steps accomplished by the shared services portion 48 of the hypervisor 46 of FIG. 2 in response to pending hypervisor work, e.g., work pending for the hypervisor partition 50. Turning more particularly to block 151 of FIG. 6, the shared services portion 48 of the hypervisor 46 may generate a hypervisor decrementor interrupt, which functions to give control of the resource to the hypervisor 46. Such hypervisor decrementor interrupts are typically generated periodically. At block 152, the hypervisor 46 determines that it has work pending. The hypervisor 46 may then determine at block 154 whether a guarantee period is in effect. If so, the hypervisor 46 will not preempt the virtual processor 13 so long as the guarantee period has not expired, as shown at blocks 154 and 156 of FIG. 6.

Alternatively, if the hypervisor 46 has work to do and the guarantee period has expired at block 154, then the hypervisor 46 may preempt the partition's access to the physical processor 12 or other resource at block 158. This preemption at block 158 typically includes removing the virtual processor 14 from the physical processor 12. The hypervisor 46 may then enqueue the virtual processor 14 to the ready queue 47. The ready queue 47 includes a list of virtual processors that have work and are waiting for the hypervisor 46 to dispatch them to a physical processor 12. After a preset time, the hypervisor 46 at block 160 returns the physical processor 12 back to the control of the partition 42.

While the present invention has been illustrated by a description of various embodiments and while these embodiments have been described in considerable detail, it is not the intention of the applicants to restrict, or in any way limit, the scope of the appended claims to such detail. For instance, “guarantee” and “work pending” responses, as well as “inquiry requests” are used for explanatory reasons, and descriptions should not be used to limit the types and names of communications that may alternatively be used. As such, additional advantages and modifications will readily appear to those skilled in the art. The invention in its broader aspects is therefore not limited to the specific details, representative apparatus and method, and illustrative example shown and described. For instance, one skilled in the art will appreciate that the above processes may be accomplished where the a partition runs on a multithreaded processor and/or a processor that supports simultaneous multithreading. In such an instance, only one thread of the processor has to make a yield call to give control of the processor to the hypervisor. One skilled in the art will further appreciate that in another embodiment, a partition may accomplish non-sensitive work, rather than no work, i.e., idling, in response to receiving a work pending response from the hypervisor. Accordingly, departures may be made from such details without departing from the spirit or scope of applicant's general inventive concept.

What is claimed is:

1. A method for managing access to a plurality of physical resources within a logically partitioned data processing system, wherein the system supports a plurality of partitions, wherein the system is configured to assign ownership of the plurality of physical resources to the plurality of partitions, the method comprising:
granting a preset period of uninterrupted use of a resource for a partition; and
inhibiting preemption of the resource during the preset period.

2. The method of claim 1, wherein granting the preset period further includes determining and programming the preset period.

3. The method of claim 1, further comprising creating at the partition an inquiry communication configured to prompt a guarantee response.

4. The method of claim 3, wherein granting the preset period further includes creating the guarantee response in response to receiving the inquiry communication.

5. The method of claim 4, further comprising scheduling work to be performed by the partition in response to receiving the guarantee response at the partition.

6. The method of claim 3, further comprising creating a work pending response in response to receiving a second inquiry communication created by the partition.

7. The method of claim 6, further comprising creating a yield call in response to receiving the work pending response at the partition.

8. The method of claim 1, wherein granting the preset period further includes determining if hypervisor work is pending.

9. The method of claim 1, further comprising enabling the resource to be preempted in response to an expiration of the preset period.

10. The method of claim 1, further comprising using the resource by at least one of a hypervisor and the partition.

11. A method for managing access to a plurality of physical resources within a logically partitioned data processing system, wherein the system supports a plurality of partitions, wherein the system is configured to assign ownership of the plurality of physical resources to the plurality of partitions, the method comprising:
determining if work is pending in response to an inquiry; and
guaranteeing no preemption of a physical resource from a partition if no work is pending.

12. An apparatus comprising:
a logically partitioned computer supporting a plurality of partitions, wherein the computer is configured to assign ownership of a plurality of physical resources to the plurality of partitions; and
program code resident in the logically partitioned computer, the program code configured to grant a preset period of uninterrupted use of a physical resource to a partition among the plurality of partitions.

13. The apparatus of claim 12, wherein the resource includes at least one of a physical processor and a memory.

14. The apparatus of claim 12, wherein the program code initiates creating at the partition an inquiry communication configured to prompt a determination of a guarantee response.

15. The apparatus of claim 14, wherein the program code initiates creating the inquiry communication in response to determining that sensitive work needs to be accomplished by the partition.

16. The apparatus of claim 12, wherein the program code initiates determining if hypervisor work is pending.

17. The apparatus of claim 16, wherein the program code initiates creating a guarantee response in response to receiving an inquiry communication if no hypervisor work is pending.

18. The apparatus of claim 17, wherein the program code initiates scheduling work to be performed by the partition in response to receiving the guarantee response at the partition.

19. The apparatus of claim 16, wherein the program code initiates creating a work pending response in response to receiving an inquiry communication if hypervisor work is pending.

20. The apparatus of claim 19, wherein the program code initiates creating a yield call in response to receiving the work pending response at the partition.

21. A program product, comprising:
program code for managing access to a plurality of physical resources within a logically partitioned data processing system, wherein the system supports a plurality of partitions, wherein the program code is configured to assign ownership of the plurality of physical resources to the plurality of partitions and wherein at least one of the partitions includes a hypervisor partition, the program code being further configured to grant a preset period of uninterrupted use of a physical resource for a partition; and
a computer readable signal bearing medium bearing the first program.
